(19) United States
(12) Patent Application Publication
(10) Pub. No.: US 2024/0351247 A1
(43) Pub. Date: Oct. 24, 2024

(54) METHOD AND DEVICE FOR PROCESSING PET POLYMERS IN ORDER TO FORM PELLETS

(71) Applicant: Maag Germany GmbH, Grossostheim (DE)

(72) Inventors: Frank GLÖCKNER, Aschaffenburg (DE); Michael ELOO, Xanten (DE); Jürgen VELTEL, Kevelaer (DE); Stephan Dietmer WILHELMI, Ærøskøbing (DK)

(73) Assignee: Maag Germany GmbH, Grossostheim (DE)

(21) Appl. No.: 18/745,716

(22) Filed: Jun. 17, 2024

Related U.S. Application Data
(63) Continuation of application No. PCT/EP2022/079263, filed on Oct. 20, 2022.

(30) Foreign Application Priority Data
Dec. 16, 2021 (DE) 102021133419.5

(51) Int. Cl. B29B 9/06; B29B 9/16; B29K 67/00

(52) U.S. Cl. CPC B29B 9/065; B29B 9/16; B29B 2009/166; B29K 2067/003

(57) ABSTRACT

The invention relates to a method for processing PET polymers in order to form PET pellets. A PET melt is granulated in an underwater granulator in order to form PET pellets, wherein the process water is driven at a temperature below the glass transition temperature of the used PETs in order to produce a golf ball-like surface structure on the pellets during the underwater granulation process. According to the invention, the pellets are separated from the super-cooled process water within a second or less and are subjected to an at least two-stage post-treatment process after the drying process, wherein the pellets are supplied with a gas of a first temperature which is higher than the surface temperature of the pellets for a first period of time, said gas being kept uniformly hot, in a first post-treatment chamber to form nuclei, and the pellets are treated in a second post-treatment chamber to crystallize at a second temperature which is higher than the first temperature over a second period of time which is a multiple of the first period of time.

### CROSS-REFERENCE TO RELATED APPLICATIONS

This application is a continuation of International Patent Application Number PCT/EP2022/079263 filed Oct. 20, 2022, which claims priority to German Patent Application Number DE 10 2021 133 419.5 filed Dec. 16, 2021, which are incorporated herein by reference in their entireties.

### BACKGROUND

The present invention relates generally to granules and pellets of polymers such as PET pellets. The invention relates in this respect on the one hand to a process for processing PET polymers in order to produce PET pellets, in which PET melt is granulated in an underwater granulator in order to produce PET pellets which, in a mixture with process water, are supplied from the underwater granulator to a dryer via a discharge line and are discharged from the dryer to a post-treatment station, wherein the process water is driven at a temperature below the glass transition temperature of the PET polymers used in order to produce a golf ball-like surface structure on the PET pellets. On the other hand, the invention relates to a device for processing PET polymers into PET pellets, comprising an underwater pelletizer, a dryer and a post-treatment station for post-treatment of the dried pellets.

In order to produce plastic pellets such as PET pellets, underwater pelletizers have been used for some time, which cut the melt strands emerging from a die plate into pellets in a cutting or pelletizing chamber filled with process water by means of a rotating cutter head. The polymer melt is forced through the die plate by means of an extruder or another suitable feeder at a temperature above the melt temperature, so that polymer melt strands enter the pelletizing chamber filled with process water, in which they are then cut by the cutter head, wherein the pelletizing chamber is flushed by the process water so that a mixture of pellets and process water is discharged from the pelletizing chamber via a discharge line and conveyed into the dryer, which may be a centrifugal dryer and separates the process water from the pellets. The separated process water is usually returned to the pelletizing chamber, resulting in a cycle.

The pellets dried in the dryer are usually not yet finished, but are subjected to post-treatment in order to achieve the desired pellet properties. On the one hand, the pellets coming out of the underwater pelletizer are usually amorphous and therefore relatively sticky on the surface, so that they are subjected to crystallization, which reduces the stickiness and facilitates further handling. Crystallization of the pellets can be achieved or facilitated by supplying heat after the dryer, or can also take place by way of self-crystallization if the pellets still have sufficient intrinsic heat, which can be facilitated, for example, by injecting compressed gas, in particular an inert inert gas, into the discharge line between the underwater pelletizer and the dryer, so that a pellet/gas/process water mixture forms and the relatively cold process water can extract less heat from the pellets, cf. for example the EP 16 84 961 B1.

On the other hand, however, it is desirable to freeze the PET pellets, so to speak, using cold process water in order to improve the reactivity of the pellets for the post-treatment steps. For this purpose, the process water can be driven at a temperature below the glass transition temperature T_{g} of the PET polymer composition used in order to produce a golf ball-like, correspondingly rough surface structure on the pellets, which increases their surface area and ultimately leads to a higher reactivity and also improves the decontamination properties in order to be able to remove unwanted ingredients or by-products from the pellets via the surface. A large surface area helps to improve the diffusion gradient of the pellets to the pellet surface that comes into contact with the inert gas such as N₂ or CO₂ or then also air. The reactivity of the pellets is of particular importance in order to achieve good results in post-treatment processes such as dealdehydization and solid-state polycondensation. In addition, quenching the pellets with super-cooled process water reduces the release of acetaldehyde and other by-products from the pellets. These by-products, in particular acetaldehyde, adversely change the pH value (acidic) of the process water through the effects of heat and oxygen in the air, so that wear on the die plate and knives is significantly reduced and other parts that come into contact with the process water are also subject to noticeably higher wear.

The golf ball structure produced on the surface of the pellets by quenching not only helps to increase the surface area and improve reactivity, but also reduces surface contact or the contact area of pellets touching each other and thus counteracts the tendency for the sticky pellets to cake together.

On the other hand, excessive quenching of the pellets can not only prevent or at least impair crystallization of the pellets by way of self-crystallization, but also prevent uniform crystallization of the pellets with a high crystallite content distributed over the entire pellets. In this respect, it is difficult to supply the heat required for crystallization to pellets that have been excessively quenched and then dried in the dryer, in particular with regard to the uniformity of heat distribution in the pellet cross-section, as heat that is subsequently supplied from the outside, for example, can only slowly work its way into the core of the pellets. In this respect, the pellets are very sensitive to crystallization in terms of pellet temperature and heat distribution in the pellet. In this respect, crystallization is not only impaired by excessive heat dissipation, but also by excessive heat input.

Against this background, it is the object of the present invention to provide an improved method and an improved device of said type for processing PET polymers into PET pellets, which avoid the disadvantages of the prior art and further develop the latter in an advantageous manner. In particular, the aim is to create pellets with high reactivity and good decontamination properties that are equally suitable for achieving uniform crystallization with a high crystallite content.

### SUMMARY

According to the invention, said task is solved by a method according to claim 1 and a device according to claim 15. Preferred embodiments of the invention are the subject of the dependent claims.

It is therefore proposed to quench the pellets strongly with cold process water below the glass transition temperature of the respective polymer composition used, but to shorten the residence time in the process water to such an extent that the strong quenching only occurs on the surface of the pellets and a golf ball-like surface structure with high roughness is configured there in the desired manner. The pellets prepared in this way for post-treatment are then subjected to a two-stage post-treatment process after drying in the dryer, in which in a first post-treatment step a strong nuclei formation is initiated at only a slightly increased temperature over a shorter treatment time and then in a second post-treatment step the desired post-treatment result is achieved at a more increased temperature over a longer time.

According to the invention, it is provided that the pellets are separated from the cold process water, which is temperature-controlled below the glass transition temperature of the polymer material used, within one second or less and are subjected to at least two-stage post-treatment after the drying process, wherein the pellets are treated by supplying gas of a first temperature, which is higher than the surface temperature of the pellets, for a first period of time in a first post-treatment chamber to form nuclei, and the pellets are treated in a second post-treatment chamber to crystallize at a second temperature, which is higher than the first temperature, over a second period of time which is a multiple of the first period of time.

The two-stage post-treatment process in post-treatment chambers at different temperatures over different periods of time can result in facilitating the forming of nuclei in the pellets, which ultimately enables more uniform crystallization with increased crystallite content. In the first post-treatment chamber, where the gas temperature is only slightly higher than the surface temperature and the treatment time is relatively short, the nucleus in the pellets can form undisturbed without undesirably high temperature gradients in the pellet impairing the formation of the nuclei. The temperature-controlled gas supply ensures a comparative, gentle nest heat that promotes the forming of nuclei without excessive supply or discharge of heat. In the second post-treatment step, more nuclei growth is facilitated and crystallization is initiated or continued. The amount or size of the nuclei ultimately determines the amount and density and size of the crystallites in the PET pellets, so that in particular a more uniform crystallization of the pellets with high crystallite contents can be achieved.

In an advantageous further development of the invention, the pellets can be separated from the super-cooled process water of the underwater pelletizer in even significantly shorter residence times of significantly less than one second. Advantageously, provision can be made for residence times of the granulated pellets in the process water of less than 0.5 seconds or even less than 0.3 seconds or even less than 0.1 seconds. In order to achieve such short residence times in the super-cooled process water, very high process water flow velocities can be used in the pelletizing chamber and/or in the discharge line and/or a very short discharge line can be provided between the underwater pelletizer and the dryer.

For example, the discharge line from the underwater pelletizer to the dryer can have a length of less than three meters or less than one meter or less than half a meter and/or be formed as straight as possible, for example having only one or two curved portions or none at all. As an alternative or in addition to a shortened discharge line, the process water velocity can be achieved by selecting sufficiently high flow rates and/or sufficiently high ratios between flow rate and line cross-section.

In particular, a high process water velocity or a very low residence time of the pellets in the process water can also be achieved or supported by measures in the area of the pelletizing chamber. In particular, the residence time in the pelletizing chamber itself can be significantly reduced by the fact that the process water inlet into the pelletizing chamber and/or the process water outlet from the pelletizing chamber, i.e. the outlet for the pellet-process water mixture, is guided tangentially into or out of the process chamber, or is discharged at least approximately tangentially to or from the circumferential surface of an approximately cylindrical pelletizing chamber. The process water inlets and outlets can also be arranged around the circumference of the pelletizing chamber in such a way that the circumferential distance from the inlet to the outlet is less than 180° or less than 120°, for example the outlet can be arranged 90° after the inlet. This allows the pellet/process water mixture forming in the pelletizing chamber to be flushed out quickly, thus reducing the residence time.

Alternatively, or additionally, provision can be made for a pump wheel in the pelletizing chamber, for example configured on the cutter head, in order to even out the discharge of the pellet process water mixture in the pelletizing chamber and convey it further.

Due to the very short residence times in the process water, it is possible to work with more super-cooled process water. In particular, the process water can be driven well below the temperature below the glass transition temperature, for example in a temperature range of 40° to 80° or 45° to 75° or 50° to 70° or 50° to 60°. This results in strong quenching, which, however, remains limited to the surface layer of the pellets, so that a high degree of roughness can be achieved on the surface through the formation of a golf ball structure by strong freezing of the surface layer, while on the other hand the pellets inside retain a relatively constant temperature over a larger diameter range, which then facilitates the forming of nuclei after drying.

In order to keep the pellets uniformly hot in the first post-treatment step, which is intended to enable and reinforce the forming of nuclei, and to avoid major temperature shifts or heat transfers, the first post-treatment chamber may comprise a vibratory conveyor which keeps the pellets in slight motion, wherein the pellets are simultaneously flowed with the gas being kept uniformly hot, the temperature of which is preferably kept in a range of 10° to 40° above the surface temperature of the pellets.

For example, the gas in the first post-treatment chamber may be maintained at said first temperature in a range of 130° to 180° or 140° to 170°.

In order to be able to expose the pellets in the first post-treatment chamber to an actually uniform gas temperature, said vibratory conveyor can be surrounded by an enclosure into which the temperature-controlled gas is blown. For example, the gas can be blown onto the pellets through a perforated, configured support surface of the vibratory conveyor. Alternatively, or additionally, it is also possible to circulate the temperature-controlled gas within the enclosure and/or to blow temperature-controlled gas through the enclosure.

In said first post-treatment chamber, the residence time of the pellets to form nuclei can be relatively short, for example in the range of a few minutes. Preferably, the treatment time in the first post-treatment chamber is about a quarter of a minute to five minutes or one minute to three minutes. In particular, a treatment duration of one minute to two minutes can be provided.

The use of a vibratory conveyor is not only advantageous to avoid caking of the not yet crystallized pellets, but it also supports a uniform temperature application, as the pellets are easily kept in motion and can thus be more evenly flowed around by the temperature-controlled gas.

The temperature in the second post-treatment chamber can then be more or less significantly higher than in the first post-treatment chamber, for example 10° to 50° or 20° to 40° hotter than the temperature of the uniformly temperature-controlled gas in the first post-treatment chamber.

The second post-treatment chamber can have a preferably actively temperature-controlled chamber wall and/or support surface for the pellets in order to control heat transfer between the pellets and the container or support wall and to avoid heat loss from the pellets in order to achieve uniform heat treatment.

In a further development of the invention, the second post-treatment chamber can be temperature-controlled to a temperature in the range of 160° to 230° or 180° to 205° or 190° to 200° at its chamber wall and/or at the support surface for the pellets.

Alternatively, or in addition to temperature control of the container or support wall, the pellets can also be supplied with a gas being kept uniformly hot in the second post-treatment chamber, which can preferably have a temperature in the range of 140° to 220°.

Depending on which post-treatment of the pellets is to be achieved or in the foreground, the temperatures in the second post-treatment chamber can be adjusted, for example in such a way that the pellets have a temperature in the range of 140° to 160° for the crystallization process. For the subsequent process of dealdehydration and/or solid-state polycondensation (SSP), the heat treatment in the second treatment chamber can be driven in such a way that the chamber wall can reach 160-195° C. (dealdehydration) or 195-215° C. (SSP). 9 The pellet temperature in the second post-treatment chamber is controlled by the extremely short contact time of the pellets with the process water. The shorter the contact time, the larger the hot core and the thinner the colder frozen pellet layer, so that the final pellet temperature is reached in the second post-treatment chamber after the pellets have equalized in temperature.

The post-treatment duration in the second post-treatment chamber is preferably a multiple of the post-treatment duration in the first post-treatment chamber. Preferably, the pellets can be aftertreated in the second post-treatment chamber for at least five times longer or at least ten times longer than in the first post-treatment chamber.

For example, the pellets can be aftertreated in the temperature-controlled and possibly gas-filled container for the second aftertreatment for a period in the range of 15 to 180 minutes or 60 to 120 minutes.

### BRIEF DESCRIPTION OF THE DRAWINGS

The invention is explained in more detail below with reference to a preferred embodiment and associated drawings. The drawings show:

FIG. 1 a representation of a device for treating PET polymers in order to produce PET pellets according to an advantageous embodiment of the invention, wherein an underwater pelletizer, a downstream dryer and two separate post-treatment chambers arranged downstream of the dryer are shown,

FIG. 2 a perspective view of the first post-treatment chamber of FIG. 1, which comprises a vibratory conveyor with an enclosure through which temperature-controlled gas is circulated,

FIG. 3 a perspective view of the vibratory conveyor from FIG. 2 together with the heating air system connected thereto for circulating heating air or gas through the enclosure of the vibratory conveyor,

FIG. 4 a sectional view of the temperature-controlled conditioning container for the second post-treatment chamber, showing the actively temperature-controlled container wall,

FIG. 5 an exploded perspective view of the pelletizing chamber of the underwater pelletizer from FIG. 1, showing the tangential inlets and outlets for the process water of the pelletizing chamber and the flow generators arranged in the pelletizing chamber in the form of a pump wheel,

FIG. 6 a perspective sectional view through the pellets quenched by the process water of the bottom pelletizer, wherein the temperature distribution in the pellets is shown for different process water temperatures and different residence times,

FIG. 7 a representation of the surface structures that form at different process water temperatures, and

FIG. 8 a representation of the forming of nuclei of the pellets frozen on the surface and the effect of the forming of nuclei on the subsequent crystallization.

### DETAILED DESCRIPTION

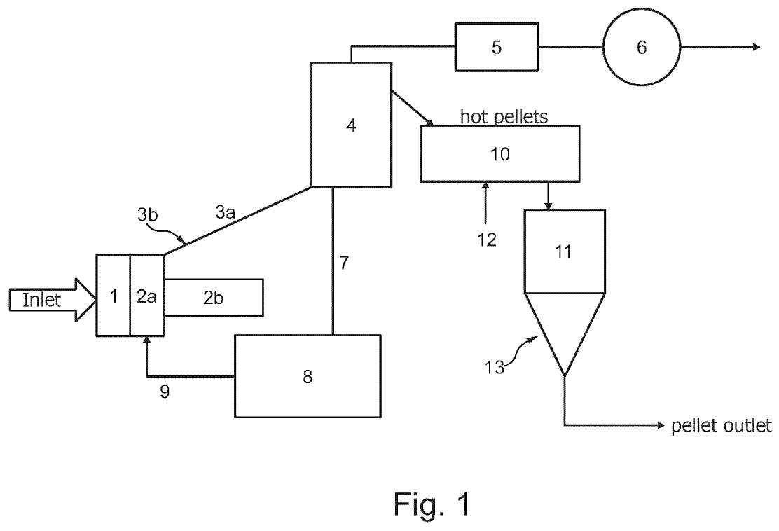

As FIG. 1 shows, the device for producing PET pellets comprises an underwater pelletizer 2, into the pelletizing chamber 2a of which polymer melt strands enter via a die plate 1 and are pelletized into pellets in the pelletizing chamber 2a by a rotating cutter head 2c, the blades of which sweep along the die plate 1.

Process water flows through the pelletizing chamber 2a and is discharged together with the pelletized pellets via a discharge line 3a and supplied to a dryer 4, in which the process water is separated from the pellets. Said dryer 4 can be a centrifugal dryer, for example, in which rotating conveyor paddles in a stationary, cylindrical screen convey the pellet-process water mixture upwards and centrifuge it in the process. The process water is discharged via the sieve, while the pellets can exit from the pellet outlet at an upper end portion of the dryer to be supplied to the post-treatment stations.

The process water separated in the dryer 4 is supplied via a return line 7 to a filter system 8, from which the process water is supplied again to the pelletizing chamber 2a via a supply line 9, resulting in a process water circuit.

A temperature control device 14 can be provided in the area of the water filter 8 or elsewhere in the process water return between the dryer 4 and the pelletizing chamber 2a in order to supply the process water to the pelletizing chamber 2a at the desired process water temperature Tₚ. It should be clarified in passing that the process water does not have to be clear water in the sense of H₂O, but can contain additives in a known manner or be a liquid suitable for granulators.

The quenching of the pellets in the process water is determined on the one hand by the process water temperature and on the other hand by the residence time of the pellets in the process water from the pelletizing chamber 2a to the dryer 4, wherein the process water is supplied to the pelletizing chamber 2a at a process water temperature Tₚ in the range from 40° to 80° or 45° to 75° or 50° to 70° to produce a golf ball-like surface structure on the pellets in the manner already explained at the beginning.

The circulation speed of the process water through the pelletizing chamber 2a and the discharge line 3a is selected to be so high by corresponding delivery rates or matching the delivery rate to the pipe cross-section of the discharge line 3a that the pellets experience a residence time in the process water of less than one second or even less than 0.5 seconds or less than 0.3 seconds. In particular, the residence time in the process water can also be less than 0.1 seconds.

In order to achieve such short residence times, the length of the discharge line 3a can be sufficiently short, for example less than 3 meters or less than one meter or even less than half a meter, and the said discharge line 3a can be configured as straight as possible, for example with no or only one bend.

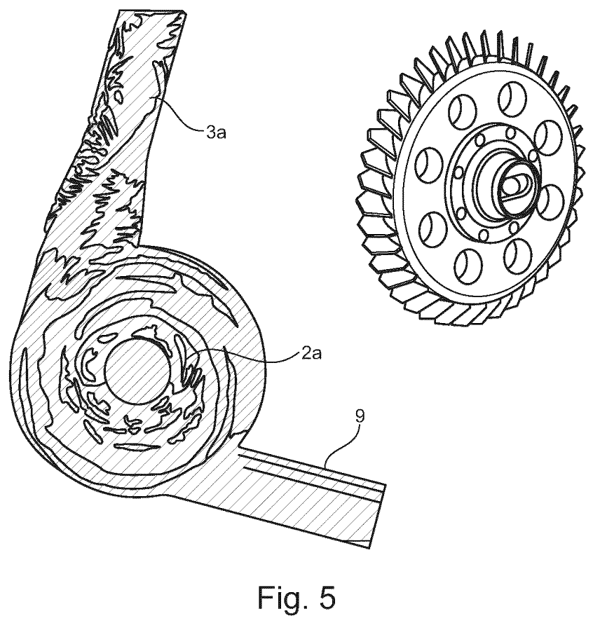

Alternatively, or additionally, a short residence time can also be supported by measures in the area of the pelletizing chamber 2a. As FIG. 5 shows, the supply line 9 for the process water into the pelletizing chamber 2a and also the discharge line 3a for discharging the process water-pellet mixture can be arranged tangentially to the circumferential region of the overall approximately cylindrical pelletizing chamber, wherein the supply line 9 and the discharge line 3 with the pelletizing chamber 2a can be arranged in adjacent sectors, so that the circumferential distance from the opening of the supply line 9 into the pelletizing chamber 2a to the opening of the pelletizing chamber 2a into the discharge line 3a can be less than 120°, for example about 90°, cf. FIG. 5.

Alternatively, or additionally to such a tangential arrangement of the inlet and outlet lines, a flow generator in the form of a pump wheel that affects the flow conditions of the process water can also be provided inside the pelletizing chamber 2a in order to convey the process water quickly through the pelletizing chamber.

Such a pump wheel can be provided on the cutter head for granulating the melt strands or configured thereon, for example in the form of pump wheel blades, which can be provided on the periphery of the cutter head, cf. FIG. 5.

In order to avoid producing excessive heat extraction from the pellets even when the process water is highly super-cooled, a gas injector 3b can advantageously be assigned to the discharge line 3 in order to inject a preferably inert gas, in particular inert gas, into the discharge line 3a at high speed and/or high pressure, preferably at an upstream end of the discharge line 3a. The process water/gas mixture that forms in the discharge line 3a, which also contains the pellets, greatly reduces the heat extraction from the pellets.

As shown in FIG. 1, the separated process water and the still hot pellets are discharged from the dryer 4. In addition, a steam or mist outlet can be provided at the upper end of the dryer 4 in order to supply the process water vapor or mist to a separator 5 or condenser and, if necessary, then through a dryer or a fan 6.

As shown in FIG. 1, the dried, still hot pellets coming out of the dryer 4 are supplied to a two-stage post-treatment process comprising two separate and differently 22 configured post-treatment chambers 10 and 11.

In the first post-treatment chamber 10, the pellets are aftertreated for a relatively short time at only a slightly increased temperature in order to promote the forming of nuclei, wherein the pellets are treated at a first temperature, which is a little above the surface temperature of the pellets, while the ambient air is kept uniformly warm. The gas temperature T1 in the first post-treatment chamber 10 can be driven in the range from 130° to 180° or 140° to 170°. If the pellets enter said post-treatment chamber 10 with a surface temperature of 100° to 140° or 110° to 130° or about 120°, the temperature T1 of the ambient air of the post-treatment chamber 10 can be run about 20° to 40° above said surface temperature of the pellets.

Advantageously, the pellets can be treated in the first post-treatment chamber 10 over a period of time t1 in the range of 15 to 140 seconds, for example one to two minutes.

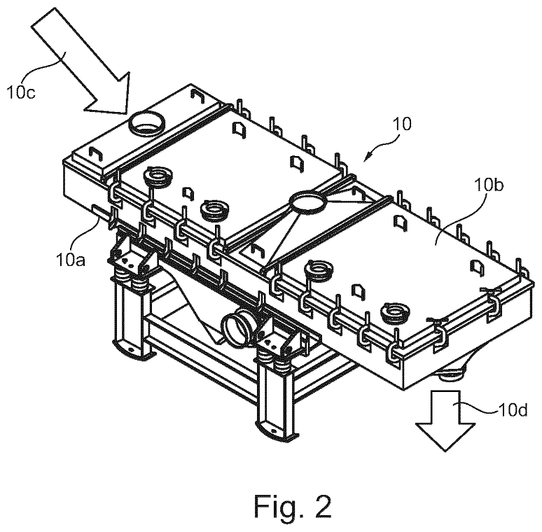

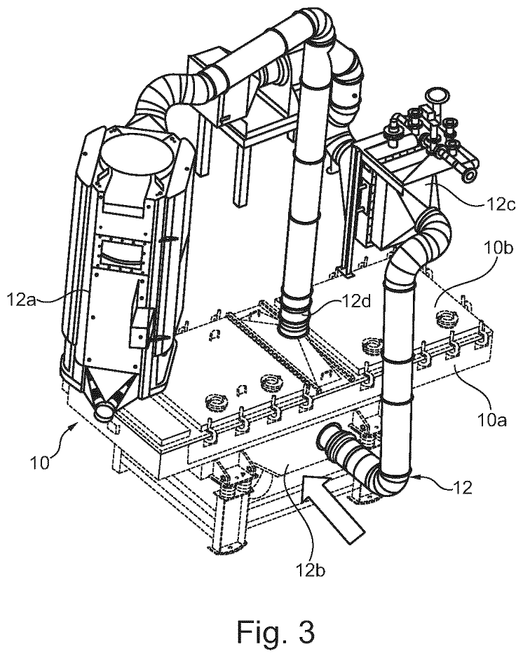

As FIG. 2 and FIG. 3 show, the first post-treatment chamber 10 may comprise a vibratory conveyor, for example in the form of a vibrating chute with a vibratory drive, to continuously convey the pellets through the first post-treatment chamber 10.

The vibratory conveyor 10a can comprise an enclosure 10b in order to be able to ensure a uniform ambient air temperature around the pellets, wherein hot air and/or gas can be supplied through the enclosure 10b from a hot air device 12, cf. FIG. 1.

As FIG. 3 shows, the hot air can be supplied to the hot air device 13 through the perforated support surface of the vibratory conveyor 10a, for example, in order to be directed from below through the support surface onto the pellets located there, so that the pellets are, so to speak, surrounded by the hot air. At a ceiling of the enclosure 10b, the hot air can escape from the enclosure 10b again and be supplied to a dryer 12a in order to then be temperature-controlled via a heat exchanger 12b in order to again flow over the pellets in the first post-treatment chamber 10, in particular within the enclosure 10b.

As a comparison of FIGS. 2 and 3 shows, the pellets can be supplied via a pellet feed 10c at one end of the vibratory conveyor 10a and discharged at the opposite end via a pellet removal 10d, while the hot air is guided over the pellets transversely to the conveying direction of the pellets. In particular, the hot air supply 12 can be supplied from an underside of the vibratory conveyor 10a, preferably centrally and/or distributed via a hot air distributor 12b. After the hot air has flowed around and/or through the vibratory conveyor 10a, the hot air can be discharged at an upper side of the enclosure 10b via an exhaust air opening 12d and recirculated in the aforementioned manner.

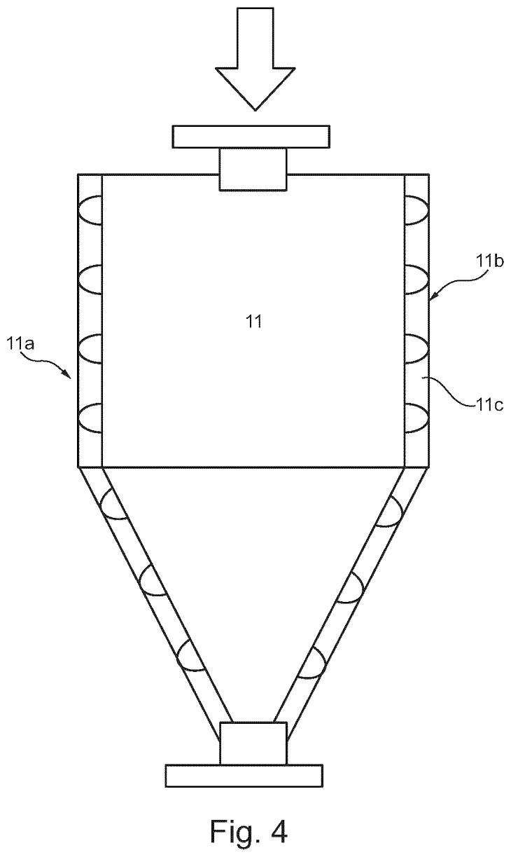

After treatment in the first post-treatment chamber 10, the pellets are supplied to the second post-treatment chamber 11, which may comprise a conditioning vessel 11a, cf. FIG. 4, in which the pellets are treated over a longer second period of time t2 of a quarter of an hour to two hours or one to two hours at an elevated temperature, preferably at a temperature in the range from 160° to 230° or 180° to 205° or 190° to 200°.

Said conditioning container 11a can have a heatable and/or coolable container wall 11b for this purpose, which can be actively temperature-controlled via a temperature control device 11c, preferably to a temperature in the range from 180° to 205°. The temperature control device 11c may, for example, comprise electrical heating and/or cooling elements, for example in the form of Peltier elements. Alternatively, or additionally, the container wall can also be heated and/or cooled via a liquid and/or gas temperature control device, for example by means of temperature control liquid and/or temperature control gas or air, which can flow through and/or around the container wall.

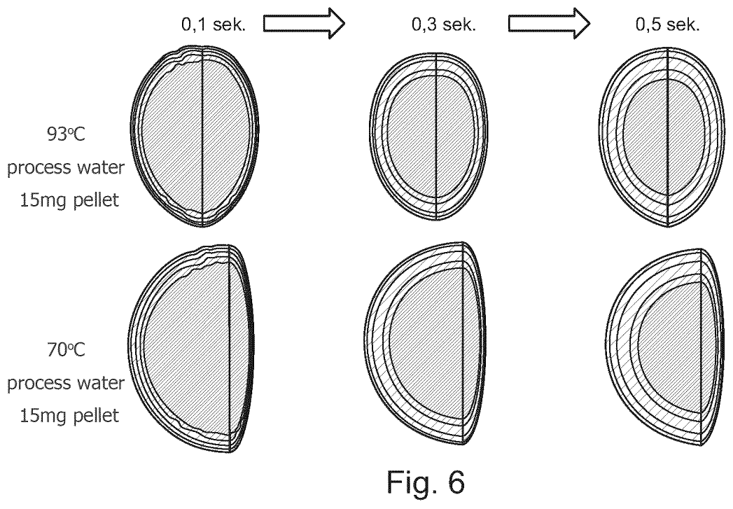

As shown in FIG. 6, quenching the pellets by the super-cooled process water can maintain a relatively uniform core temperature close to the surface layer of the pellets for only a short dwell time, while the surface layer itself undergoes a strong, golf ball-like, rough surface structuring. Looking at the bottom row of FIG. 6, for example, it can be seen that if the residence time is reduced from 0.5 seconds to 0.1 seconds, for example, the transition area between the hot pellet core and the frozen surface skin of the pellets can be significantly reduced, i.e. the hot pellet core extends significantly further into the outer layers of the pellet.

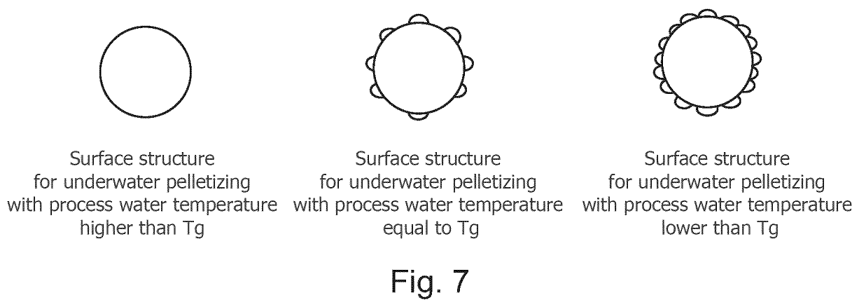

FIG. 7 illustrates the effect of a stronger undercooling of the process water on the surface structure. The more the process water is cooled below the glass transition temperature T_{g} of the polymer, the more a golf ball-like surface structure is formed. While no surface structure is formed at all at process water temperatures above the glass transition temperature T_{g}, see FIG. 7 left, a slight surface structure can be achieved at process water temperatures at the level of the temperature below the glass transition temperature, cf. FIG. 7 center. A strong surface structuring then results from significant undercooling below the glass transition temperature, cf. FIG. 7 right. The stronger the undercooling, the stronger the golf ball-like surface structure forms.

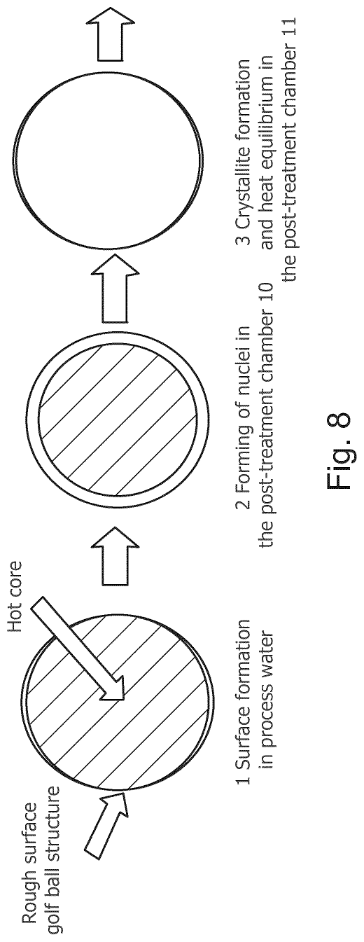

FIG. 8 illustrates the forming of nuclei in the pellets pretreated in this way. If the pellet, which is heavily frozen on the surface, enters the first post-treatment chamber 10 after a very short residence time in the process water, there can be formed a large nuclei, cf. FIG. 8 left and center. With such strong forming of nuclei, the crystallite formation that then takes place can be effective, so that pellets with a high crystallite content can be produced evenly distributed over the pellet, cf. FIG. 8 right.

We claim:

1. A method for processing PET polymers in order to form PET pellets, comprising: dividing PET melt into PET pellets in an underwater pelletizer; supplying pellets in a mixture with process water via a discharge line from the underwater pelletizer to a dryer discharging the pellets from the dryer to a post-treatment station; keeping the process water at a process water temperature below a glass transition temperature of the PET polymers used in order to produce a golf ball-like surface structure on the PET pellets; separating the pellets from the process water within one second or less; aftertreating after the drying in an at least two-stage aftertreatment process; wherein the aftertreating comprises first supplying which the pellets with a gas; keeping the gas uniformly hot at a first temperature higher than a surface temperature of the pellets for a first period of time in a first post-treatment chamber to form nuclei, and wherein the aftertreating comprises treating the pellets in a second post-treatment chamber for crystallization and/or dealdehydization and/or solid-state polycondensation at a second temperature, higher than the first temperature over a second period of time, which is a multiple of the first period of time.

2. The method of claim 1, further comprising conveying the pellets from a pelletizing chamber of the underwater pelletizer via the discharge line into the dryer within less than 0.5 seconds.

3. The method of claim 2, further comprising injecting compressed air and/or compressed gas into the upstream end portion of the discharge line immediately after the pelletizing chamber to produce an air/gas process water/pellet mixture in the discharge line.

4. The method of claim 1, further comprising supplying the process water to the at least approximately cylindrical pelletizing chamber of the underwater pelletizer in an at least approximately tangential direction; and discharging from the pelletizing chamber into the discharge line in an at least approximately tangential direction.

5. The method of claim 4, further comprising bringing the process water in the pelletizing chamber into turbulence by a pump wheel comprising a cutter head; and mixing the process water with the pellets.

6. The method of claim 1, further comprising maintaining the process water in the pelletizing chamber of the underwater pelletizer at a process water temperature in a range from 40° C. to 80° C.

7. The method of claim 1, further comprising keeping the pellets in the first post-treatment chamber in motion by a vibratory conveyor; flowing the pellets with the gas; and keeping the gas uniformly hot at the first temperature in a range of 20° C. to 40° C. above the surface temperature of the pellets.

8. The method of claim 7, further comprising keeping the gas uniformly hot at the first temperature in a range of 130° C. to 180° C. in the first post-treatment chamber.

9. The method of claim 1, further comprising treating the pellets in the first post-treatment chamber for the first period of time ranging from a quarter of a minute to 5 minutes.

10. The method of claim 1, further comprising keeping the second temperature in the second post-treatment chamber 10° C. to 50° C. warmer than the first temperature of the uniformly hot tempered gas in the first post-treatment chamber.

11. The method of claim 1, wherein the second post-treatment chamber comprises a temperature-controlled chamber wall and/or a temperature-controlled support surface for the pellets, further comprising maintaining the chamber wall and/or support surface for the pellets at the second temperature in a range from 160° C. to 230° C.

12. The method of claim 1, further comprising flowing the pellets in the second post-treatment chamber with a gas; and keeping the gas uniformly hot at a gas temperature of 140° C. to 220° C.

13. The method of claim 1, further comprising aftertreating the pellets in the second post-treatment chamber at least 5 times longer than in the first post-treatment chamber.

14. The method of claim 1, further comprising aftertreating the pellets are in the second post-treatment chamber for the second period of time in a range of 15 minutes to 180 minutes.

15. A device for processing PET polymers in order to obtain PET pellets, comprising:
an underwater pelletizer configured to underwater pelletize PET melt into PET pellets,
a dryer downstream of the underwater pelletizer, connected to the underwater pelletizer via a discharge line that is configured to receive a pellet-process water mixture from the underwater pelletizer, and
a post-treatment station for post-treatment of the pellets dried in the dryer,
wherein the underwater pelletizer comprises a tempering device for tempering the process water to a process water temperature below a glass transition temperature of the PET polymer used, wherein the underwater pelletizer and the discharge line are configured to convey the pellets into the dryer within one second or less and to separate the pellets from the process water, further comprising an after-treatment station comprising at least two separate and differently configured after-treatment chambers, of which a first after-treatment chamber for forming nuclei comprises a gas tempering device for supplying the pellets with a gas of a first temperature kept uniformly hot, higher than the surface temperature of the pellets for a first period of time, and the second post-treatment chamber for crystallizing the pellets comprises a temperature control device for controlling a surface temperature of a chamber wall and/or a support surface for the pellets to a second temperature greater than the first temperature of the gas in the first post-treatment chamber, for a second period of time which is a multiple of the first period of time.

16. The device of claim 15, wherein the first post-treatment chamber further comprises a vibratory conveyor for keeping the pellets in motion.

17. The device of claim 16, wherein the vibratory conveyor of the first post-treatment chamber is surrounded by an enclosure, within which the pellets on the vibratory conveyor are supplied with the gas being kept uniformly hot at the first temperature.

18. The device of claim 15, wherein the second post-treatment chamber comprises a conditioning container with temperature-controlled container wall, wherein a temperature-controlling device for temperature-controlling the container wall is configured to maintain the container wall at a conditioning temperature in a range from 180° C. to 205° C.
